(19) United States
(12) Patent Application Publication
(10) Pub. No.: US 2019/0208501 A1
(43) Pub. Date: Jul. 4, 2019

(54) Paging Apparatus and Method and Communication System

(71) Applicant: FUJITSU LIMITED, Kawasaki-shi (JP)

(72) Inventors: Wei XI, Beijing (CN); Hua ZHOU, Beijing (CN)

(73) Assignee: FUJITSU LIMITED, Kawasaki-shi (JP)

(21) Appl. No.: 16/299,718

(22) Filed: Mar. 12, 2019

Related U.S. Application Data
(63) Continuation of application No. PCT/CN2016/099575, filed on Sep. 21, 2016.

(51) Int. Cl. H04W 68/02; H04B 7/024

(52) U.S. Cl. CPC H04W 68/02; H04B 7/024

(57) ABSTRACT

A paging apparatus and method and a communication system. The paging method includes: determining a paging occasion of a user equipment based on one or more beam identities in a paging set; and transmitting a beam-based paging message to the UE when the paging occasion arrives. Hence, when the paging occasion of the user equipment arrives, beams of the base station may be directed to the user equipment, and a paging message may be efficiently and reliably transmitted.

### CROSS REFERENCE TO RELATED APPLICATIONS

This application is a continuation application of International Application PCT/CN2016/099575 filed on Sep. 21, 2016, the entire contents of which are incorporated herein by reference.

### TECHNICAL FIELD

This disclosure relates to the field of communication technologies, and in particular to a paging apparatus and method and a communication system.

### BACKGROUND

As we all know, existing wireless spectra are already crowded. In order to cope with ever-increasing wireless traffics and emerging new services, people have to explore wireless spectrum resources with higher frequencies and larger bandwidths, such as centimeter waves, and millimeter waves.

However, the higher a frequency of a signal, the larger the attenuation it is subjected to. In order to overcome severe transmission loss, a large number of antennas, that is, large-scale antenna arrays, may be deployed at a transmitting device and a receiving device of a high-frequency communication link, so as to obtain a larger beamforming gain against severe transmission attenuation.

For data transmission, a base station (such as a transmission/reception point (TRP), which shall be hereinafter used as an example) may usually use user equipment (UE)-specific beamforming technique to concentrate transmission power in a direction where the user equipment is in. However, UE-specific beamforming technique is no longer applicable to common channels and signals, in which case a coverage problem of common channels and channels is an urgent problem to be solved in a high-frequency transmission scheme.

In order to ensure the coverage of common channels and signals, there are currently two types of solutions, one is multi-beam-based, and the other is single-beam-based. The multi-beam-based solution is more prospective, and thus has been paid more attention and support from the industry. In particular, a beam-sweeping-based multi-beam scheme may provide coverage in a time-division multiplexing manner, and has become a focus of discussion.

Generally speaking, there are two types of beam scanning methods: a subframe level and a symbol level, meaning that different beams are transmitted by respectively occupying different subframes and different symbols.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in the current solutions, for a certain user equipment, a paging occasion (PO) depends on a user equipment identity (UE ID), and paging timing and beam-sweeping timing of the TRP are completely independent. If in a duration of a paging occasion, a complete beam sweeping (such as an analog beam sweeping) period cannot be performed, when a paging occasion of the user equipment comes, a beam of a serving TRP is likely not directed to the user equipment, in which case the user equipment is unable to successfully receive the paging message.

And on the other hand, in addition to large propagation losses, high-frequency transmission may be subjected to severe blocking. Given a user equipment, even if the beam of the serving TRP points to it when the paging occasion arrives, if there is a blockage between them, it is likely that the user equipment still unable to successfully receive the paging message.

Embodiments of this disclosure provide a paging apparatus and method and a communication system, in which it is expected to improve transmission efficiency and reliability of a paging message.

According to a first aspect of the embodiments of this disclosure, there is provided a paging method, applicable to a base station, the paging method including:

determining a paging occasion of a user equipment based on one or more beam identities in a paging set; and

transmitting a beam-based paging message to the user equipment when the paging occasion arrives.

According to a second aspect of the embodiments of this disclosure, there is provided a paging apparatus, configured in a base station, the paging apparatus including: a paging occasion determining unit configured to determine a paging occasion of a user equipment based on one or more beam identities in a paging set; and a paging message transmitting unit configured to transmit a beam-based paging message to the user equipment when the paging occasion arrives.

According to a third aspect of the embodiments of this disclosure, there is provided a paging method, applicable to a user equipment, the paging method including:

determining a paging occasion of the user equipment based on one or more beam identities in a paging set; and

receiving a beam-based paging message when the paging occasion arrives.

According to a fourth aspect of the embodiments of this disclosure, there is provided a paging apparatus, configured in a user equipment, the paging apparatus including:

a paging occasion determining unit configured to determine a paging occasion of the user equipment based on one or more beam identities in a paging set; and

a paging message receiving unit configured to receive a beam-based paging message when the paging occasion arrives.

According to a fifth aspect of the embodiments of this disclosure, there is provided a communication system, including:

a serving base station configured to determine a paging occasion of a user equipment based on one or more beam identities in a paging set, and transmit a beam-based paging message to the user equipment when the paging occasion arrives; and

a user equipment configured to determine a paging occasion of the user equipment based on one or more beam identities in a paging set, and receive a beam-based paging message when the paging occasion arrives.

An advantage of the embodiments of this disclosure exists in that a paging occasion of a user equipment is determined based on one or more beam identities in a paging set. Hence, when the paging occasion of the user equipment arrives, beams of the base station can be directed to the user equipment, and paging messages can be efficiently and reliably transmitted.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a paging failure resulted from independent paging timing and beam sweeping timing;

FIG. 2 is a schematic diagram of a paging failure resulted from blocking between a TRP and a user equipment;

FIG. 3 is a flowchart of the paging method of Embodiment 1 of this disclosure;

FIG. 4 is another flowchart of the paging method of Embodiment 1 of this disclosure;

FIG. 5 is a schematic diagram of transmitting a paging message jointly by two TRPs of Embodiment 1 of this disclosure;

FIG. 6 is a flowchart of the paging method of Embodiment 2 of this disclosure;

FIG. 7 is another flowchart of the paging method of Embodiment 2 of this disclosure;

FIG. 8 is a schematic diagram of the paging apparatus of Embodiment 3 of this disclosure;

FIG. 9 is another schematic diagram of the paging apparatus of Embodiment 3 of this disclosure;

FIG. 10 is a further schematic diagram of the paging apparatus of Embodiment 3 of this disclosure;

FIG. 11 is a schematic diagram of the paging apparatus of Embodiment 4 of this disclosure;

FIG. 12 is another schematic diagram of the paging apparatus of Embodiment 4 of this disclosure;

FIG. 13 is a further schematic diagram of the paging apparatus of Embodiment 4 of this disclosure;

FIG. 13 is a further schematic diagram of the paging apparatus of Embodiment 4 of this disclosure;

FIG. 14 is a schematic diagram of the communication system of Embodiment 5 of this disclosure;

FIG. 15 is a schematic diagram of the user equipment of Embodiment 5 of this disclosure; and

FIG. 16 is a schematic diagram of the base station of Embodiment 5 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In this disclosure, a base station may be referred to as an access point, a broadcast transmitter, a transmission/reception point (TRP), a node B, an evolution node B (eNB), or a remote radio head/unit (RRH/RRU), etc., and may include some or all functions thereof. A term “base station” shall be used in the text, and each base station provides communication coverage for a specific geographical region. A term “cell” may refer to a base station and/or its coverage region, depending on a context where the term is used. Hereinafter, a base station may include a serving base station and/or coordination base station.

In this disclosure, a mobile station or equipment may be referred to as a user equipment (UE). The UE may be fixed or mobile, and may also be referred to as a mobile station, a terminal, an access terminal, a user unit, or a station, etc. The UE may be a cellular phone, a personal digital assistant (PDA), a wireless modem, a wireless communication device, a handhold device, a machine-type communication device, a lap-top computer, and a cordless telephone, etc.

In a long term evolution (LTE)/LTE-advanced/LTE-advanced Pro system, a paging frame (PF) is determined by a formula as below:

$$SFN mod T = \frac{T}{N} \cdot ( UE\_ID mod N ) ; \qquad ( 1 )$$

where, T is a discontinuous reception (DRX) period, and N=min(T, nB), nB∈{4T, 2T, T, T/2, T/4, T/8, T/16, T/32, T/64, T/128, T/256}.

A number i_s=└UE_ID/N┘ mod Nₛ; where, Nₛ=max (1, nB/T).

Without loss of generality, by taking that a paging radio network temporary identifier (P-RNTI) is transmitted in a physical downlink control channel (PDCCH) as an example, a paging occasion (PO) may be obtained by looking up Table 1 below.

TABLE 1

| | | PO when | PO when | PO when | PO when |
|---|---|---|---|---|---|
| | Ns | i_s = 0 | i_s = 1 | i_s = 2 | i_s = 3 |
| Frequency | 1 | 9 | N/A | N/A | N/A |
| division | 2 | 4 | 9 | N/A | N/A |
| duplexing | 4 | 0 | 4 | 5 | 9 |
| (FDD) | | | | | |
| Time | 1 | 0 | N/A | N/A | N/A |
| division | 2 | 0 | 5 | N/A | N/A |
| duplexing | 4 | 0 | 1 | 5 | 6 |
| (TDD) | | | | | |

It is obvious that for a given user equipment, a paging occasion is dependent on a user equipment identifier (UE ID). Paging timing and beam-sweeping timing are completely independent. If in a duration of a paging occasion, a complete beam sweeping (such as an analog beam sweeping) period cannot be performed, when a paging occasion of the user equipment comes, a beam of a serving base station is likely not directed to the user equipment, in which case the user equipment is unable to successfully receive the paging message.

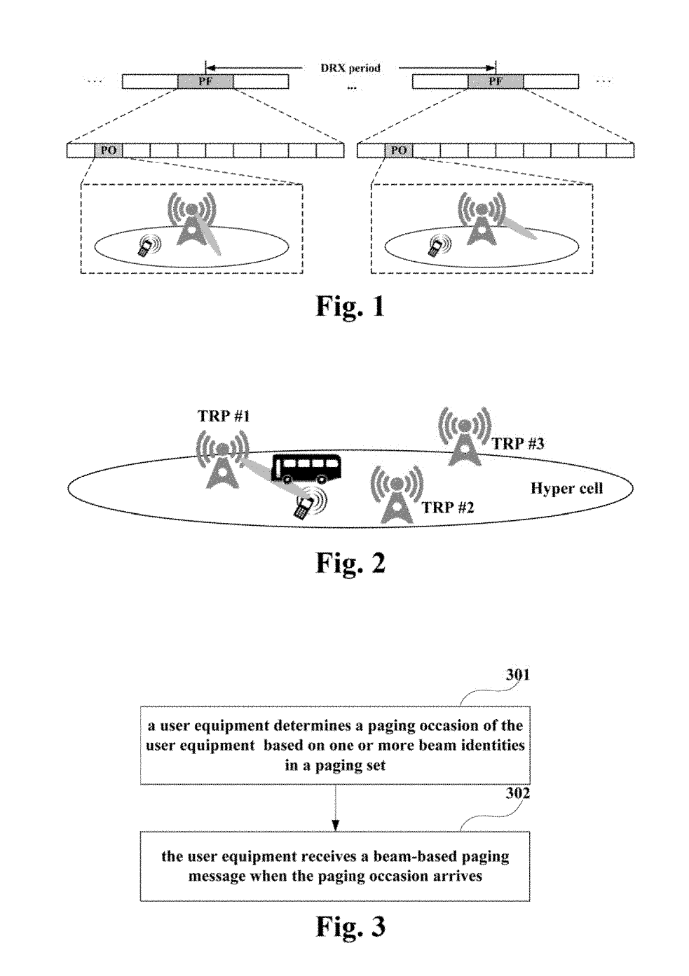

FIG. 1 is a schematic diagram of a paging failure resulted from independent paging timing and beam sweeping timing. As shown in FIG. 1, when a PO in a PF arrives, a beam transmitted by a TRP is not directed to the user equipment, thereby resulting in the user equipment to fail to successfully receive the paging message.

And on the other hand, in addition to large propagation losses, high-frequency transmission may be subjected to severe blocking. Given a user equipment, even if the beam of the serving TRP is directed to it when the paging occasion arrives, if there is a blockage between them, it is likely that the user equipment still unable to successfully receive the paging message.

FIG. 2 is a schematic diagram of a paging failure resulted from blocking between a TRP and a user equipment. As shown in FIG. 2, for example, in a hyper cell, there are three TRPs. For example, TRP #1 is a serving TRP of the user equipment. At a moment when a paging occasion of the user equipment arrives, a vehicle passes between the user equipment and TRP #1, in which case a beam of TRP #1 directed to the user equipment is blocked, thereby resulting in a paging failure.

The paging failures are schematically illustrated above. In general, in a new radio (NR) technique facing the fifth generation (5G), existing paging mechanisms may be unable to operate due to, for example, the following reasons: for a user equipment, it is likely that a beam of the serving TRP is not directed to the user equipment when a paging occasion arrives; and in high-frequency transmission, it is often that blocking results in a paging failure.

How to efficiently and reliably perform paging is crucial to a 5G wireless communication system. Embodiments of this disclosure shall be described below in detail.

### Embodiment 1

These embodiments of this disclosure provide a paging method, applicable to a user equipment.

FIG. 3 is a flowchart of the paging method of the embodiment of this disclosure, which shall be described from a view point of a user equipment. As shown in FIG. 3, the paging method includes:

Block 301: a user equipment determines a paging occasion of the user equipment based on one or more beam identities in a paging set; and

Block 302: the user equipment receives a beam-based paging message when the paging occasion arrives.

In an embodiment, a base station may be a macro base station (such as an eNB), and the user equipment is served by a macro cell generated by the macro base station; or the base station may be a pico base station, and the user equipment is served by a pico cell (or a small cell) generated by the pico base station. However, the embodiment of this disclosure is not limited thereto, and a particular scenario may be determined according to an actual situation.

In an NR system, in order to resist server propagation losses, the beamforming technique is widely used, in which case for access of a user equipment, radio resource management (RRM) measurement, etc., is usually directed to a beam, and is no longer directed to a base station (or a TRP).

For the sake of convenience of description, two different beam reference methods are given here.

The first one is global beam identifier, in which beams of a plurality of base stations (or TRPs) in an area (or a hyper cell) are uniformly numbered, denoted by a capital B′ and sub scripts.

And the second one is a binary group including a base station (or a TRP) identity and base station (or a TRP) internal beam identities, respectively denoted by lower-case letters ‘c’ and ‘b’ and subscripts.

It should be noted that the two types of beam identities are completely equivalent and interchangeable, that is, Bᵢ<=>(cₘ, bₙ); where, Bᵢ is the global beam identifier, cₘ is an identity of a base station (or a TRP) to which a beam belongs (this identity may be but not limited to a cell identity), and bₙ is an identity of a beam within a belonging base station (or a TRP). And furthermore, particular expressions of the beams are not limited thereto, and they may also be other expressions.

Without loss of generality, the user equipment may obtain a cell identity of the serving base station (or a TRP) by cell search according to a primary synchronization signal (PSS) and a secondary synchronization signal (SSS).

In a case of beam sweeping, the identity of the beam within the base station (or a TRP) is usually mapped into a symbol (such as an orthogonal frequency division multiplexing (OFDM) symbol) number (or index). In this sense, the OFDM symbol index may be taken as the identity of the beam within the base station (or a TRP). Hence, the user equipment may determine the identity of the beam within the base station (or a TRP) according to an index of an OFDM symbol with a maximum received signal strength.

For any beams that can be detected, the user equipment may obtain the global beam identity according to the cell identity of the belonging base station (or a TRP) and the identity of the beam within the base station (or a TRP). For the sake of convenience of explanation, following description shall be given by taking the global beam identity as an example.

It should be emphasized that the term “paging occasion” in the embodiments of this disclosure is a concept in a broad sense, which may have different meanings in subframe-level sweeping and symbol-level sweeping. For example, in the subframe-level sweeping, the paging occasion may be expressed as a subframe index in a frame; while in the symbol-level sweeping, the paging occasion may be expressed as not only a subframe index in a frame, but also a symbol index in the subframe.

In an embodiment, in order that the base station is able to direct a beam to the user equipment when a paging occasion of the user equipment arrives, beam sweeping timing of the base station may be associated with paging timing of the user equipment, that is, a paging set of the user equipment may be introduced into scheduling of paging occasions.

For example, given a user equipment, assuming that an identity of the user equipment is u, the paging occasion of the user equipment may be calculated according to but not limited to the following formula:

POₙ=f(Pₙ) (2);

where, Pₙ is the paging set of the user equipment, and f is a paging occasion calculation function, which may be predefined statically or notified via higher layer signaling (such as radio resource control (RRC) signaling). Reference may be made to, for example, formula (1) and Table 1, for a particular implementation off in which such parameters as T, and nB, etc., may be used. Even more, a user equipment identity in a formula of an existing LTE system may be directly replaced with a beam identity in a user equipment paging set, which is not limited in this disclosure.

In an embodiment, the paging occasion of the user equipment may be determined based on one or more beam identities in the paging set and the identity of the user equipment.

For example, given a user equipment, assuming that the identity of the user equipment is u, the paging occasion of the user equipment may be calculated according to but not limited to the following formula:

POₙ=f(u,Pᵤ) (3).

According to an actual demand, the base station may adopt a dynamic paging occasion calculation formula, for example, it may dynamically switch over between formulae (2) and (3). And the base station may notify the user equipment via higher layer signaling (such as RRC signaling), and/or physical layer signaling, and/or system information (SI), etc. Correspondingly, the user equipment may dynamically switch paging occasion calculation formulae according to corresponding signaling.

It should be noted that how to calculate the paging occasion of the user equipment is illustrated above; however, this disclosure is not limited thereto. The beam sweeping timing of the base station and the paging timing of the user equipment may be associated with each other, and a particular implementation may be determined according to an actual situation.

In an embodiment, when the paging set of the user equipment contains a plurality of beam identities, i.e. |Pᵤ|>1, the paging occasion may be determined by a part of the beam identities (i.e. one or more beam identities) in the paging set.

For example, taking a paging set containing two beam identities as an example, Pᵤ={Bᵤ₁, Bᵤ₂}, and the paging occasion may be determined in methods as below:

method 1: determining the paging occasion according to Bᵤ₁ and Bᵤ₂ and the user equipment identifier u, i.e. POᵤ=f₁(u, Bᵤ₁, Bᵤ₂); the user equipment identifier u is optional, that is, it may also be that POᵤ=f′ (Bᵤ₁, Bᵤ₂);

method 2: determining the paging occasion according to Bᵤ₁ and the user equipment identifier u, i.e. POᵤ=f₂(u, Bᵤ₁); the user equipment identifier u is optional, that is, it may also be that POᵤ=f₂(Bᵤ₁); and

method 3: determining the paging occasion according to Bᵤ₂ and the user equipment identifier u, i.e. POᵤ=f₃(u, Bᵤ₂); the user equipment identifier u is optional, that is, it may also be that POᵤ=f₃(Bᵤ₂).

Hence, the paging occasion of the user equipment may be determined based on one or more beam identities in the paging set, and when the paging occasion of the user equipment arrives, beams of the base station may be directed to the user equipment, and paging messages may be efficiently and reliably transmitted.

How to determine the paging occasion by using the paging set is illustrated above, and how to generate the paging set shall be further described below.

In an embodiment, the paging set may be generated by the user equipment based on a received signal strength. For example, the user equipment may periodically measure beam-based reference signal received power (RSRP) and/or reference signal received quality (RSRQ). And based on a result of measurement, the user equipment u may determine its paging set Pᵤ.

Furthermore, the paging set may also be configured by the base station for the user equipment; that is, the base station indicates a paging set for the user equipment (for example, the base station may measure an uplink reference signal transmitted by the user equipment, and determine the paging set of the user equipment according to result of measurement), and transmits the paging set to the user equipment, and the user equipment calculates the paging occasion of itself by using the paging set.

Following description shall be given by taking that the paging set is generated by the user equipment based on a received signal strength as an example.

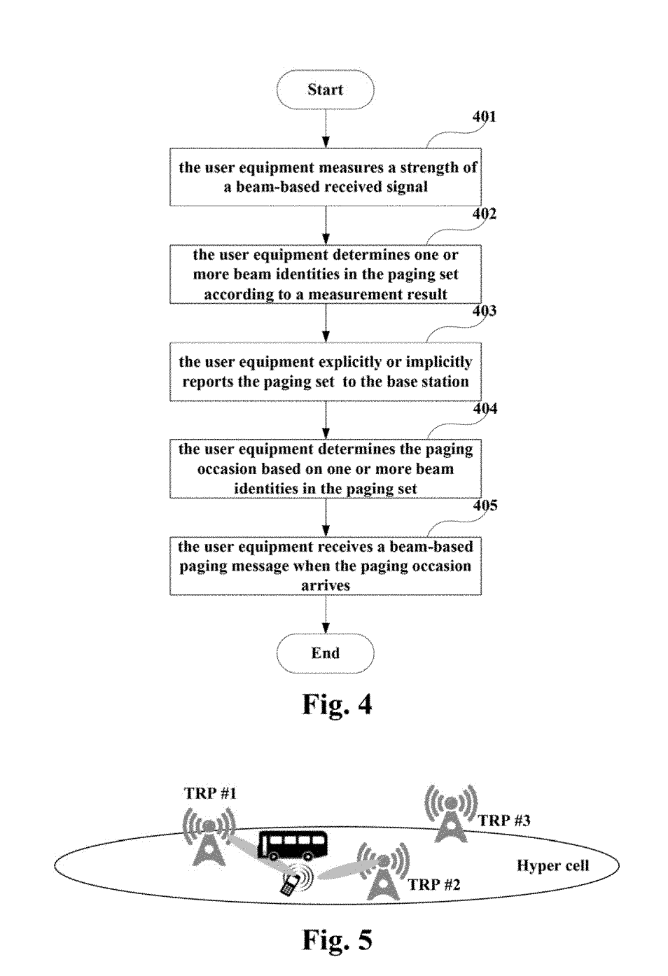

FIG. 4 is another flowchart of the paging method of the embodiment of this disclosure. As shown in FIG. 4, the paging method includes:

Block 401: a user equipment measures a strength of a beam-based received signal.

In an embodiment, the user equipment may measure a signal strength of a beam transmitted by the serving base station, and/or may measure signal strengths of beams transmitted by other base stations.

Block 402: the user equipment determines one or more beam identities in the paging set according to a measurement result.

In one embodiment, one or more beam identities to which a predetermined number of larger measurement values in the result of measurement correspond may be determined as the beam identities in the paging set.

For example, the paging set includes a given number of beam identities with larger results of measurement (for example, they all belong to the serving TRP, or belong to the serving TRP and other TRPs, or respectively belong to different TRPs), that is,

P={B₁, . . . B_{|P|}},M_{B1}≥ . . . ≥M_{B|P|}≥ . . . ≥M_{BN} (4);

where, M_{Bi} is a result of measurement (such as RSRP and/or RSRQ) base on a beam Bi, i=1, 2, . . . , N, N is a total number of beams that may be detected by the user equipment, and |P|∈[1, N] is a size of the paging set of the user equipment, which may be predefined, or may be dynamically configured and updated. And dynamically configured and updated signaling may be higher layer signaling (such as RRC signaling), and/or physical layer signaling (such as a PDCCH), and/or system information.

In this embodiment, the size of the paging set may be, for example, indicated by the base station, and transmitted to the user equipment via signaling; and the user equipment may determine one or more beam identities in the paging set according to the size of the paging set and the result of measurement.

In another embodiment, beam identities to which one or more measurement values in the result of measurement having a difference with a maximum measurement value not exceeding a predetermined threshold correspond as the beam identities in the paging set.

For example, the paging set includes beam identities having a difference with the maximum measurement value not exceeding a threshold (for example, they all belong to the serving TRP, or belong to the serving TRP and other TRPs, or respectively belong to different TRPs), that is,

P={Bᵢ|M_{B}_{ₘₐₓ}−M_{B}_{ᵢ}≤Mₜᵣ} (5);

where, Mₜᵣ is the threshold value, which may be predefined, or may be dynamically configured and updated, the dynamically configured and updated signaling being higher layer signaling (such as RRC signaling), and/or physical layer signaling (such as a PDCCH), and/or system information (SI), and is the maximum measurement value in the result of measurement.

It should be noted that when a distance between the user equipment and the serving base station (or a TRP) is relatively small, the paging set may usually contain only one beam identity (usually belonging to the serving TRP), that is, |P|=1. And furthermore, the paging set in the embodiment of this disclosure is UE-specific, that is, each user equipment may have a paging set of its own; however, this disclosure is not limited thereto.

In an embodiment, the beam identities in the paging set may include: identities of beams transmitted by the serving base station, and/or identities of beams transmitted by the other base stations.

As shown in FIG. 4, the paging method may further include:

Block 403: the user equipment explicitly or implicitly reports the paging set to the base station.

In an embodiment, after the paging set is obtained, the user equipment may feed the paging set back to the serving base station (or a TRP) in an explicit or implicit manner.

For the explicit feedback, the user equipment may periodically or aperiodically feed absolute information on the paging set back to the serving base station (or a TRP), or may periodically or aperiodically feed back incremental information on the paging set relative to a last time of feedback to the serving base station (or a TRP). And furthermore, the feedback may be performed via a physical uplink control channel (PUCCH), and/or via a physical uplink shared channel (PUSCH). However, this disclosure is not limited thereto, and a particular implementation may be determined according to an actual situation.

And for the implicit feedback, such as by downlink beam sweeping, the user equipment may learn an optimal beam of each base station (or a TRP) to the user equipment in the paging set and a corresponding downlink OFDM symbol index. According to the downlink symbol index, the user equipment may obtain an uplink subframe index corresponding to the downlink symbol index (for beam sweeping at a subframe level) or an uplink OFDM symbol index corresponding to the downlink symbol index (for beam sweeping at a symbol level). The user equipment may transmit a reference signal to a corresponding base station (or a TRP) in the uplink subframe or the uplink OFDM symbol, the reference signal carrying a user equipment identifier or a group identifier of a user equipment group to which the user equipment belongs. And according to the received reference signal, the base station (or a TRP) may learn beam identifier information on its own (i.e. the base station or a TRP) in the paging set of the user equipment.

It should be noted that the mapping from the downlink symbol index to the corresponding subframe index or the mapping from the downlink symbol index to the corresponding symbol index here needs to be learnt by both the user equipment and the base station (or a TRP). Hence, the serving base station (or a TRP) of the user equipment may configure the user equipment via higher layer signaling (such as RRC signaling), or directly adopt a static mapping manner.

As shown in FIG. 4, the paging method may further include:

Block 404: the user equipment determines the paging occasion based on one or more beam identities in the paging set; and

Block 405: the user equipment receives a beam-based paging message when the paging occasion arrives.

It should be noted that the embodiment of this disclosure is only illustrated in FIG. 4; however, this disclosure is not limited thereto. For example, an order of execution of the blocks or steps may be appropriately adjusted; and furthermore, some other blocks or steps may be added, or some of these blocks or steps may be reduced. And appropriate variants may be made by those skilled in the art according to what is described above, without being limited to the disclosure contained in the above figure.

In an embodiment, a serving base station and a coordination base station may jointly transmit the paging message of the user equipment. And when the paging occasion arrives, the user equipment may receive the paging message transmitted by the serving base station and/or the coordination base station.

In particular, when the paging occasion arrives, the user equipment may monitor and determine whether there exists the paging message of the user equipment; and when there exists the paging message of the user equipment, the user equipment receives the paging message transmitted by the serving base station and/or the coordination base station.

For example, given a user equipment, based on a report of the user equipment for the paging set, when the paging occasion of the user equipment arrives, at least one (at most |P|) base station (or a TRP) may jointly transmit the paging message of the user equipment. And the number of concerned base stations (or TRPs) is greater than 1, a problem of blocking may be efficiently solved by using a beam diversity.

FIG. 5 is a schematic diagram of transmitting a paging message jointly by two TRPs of the embodiment of this disclosure. As shown in FIG. 5, the paging set of the user equipment includes beam identities of TRP #1 and TRP #2. The two TRPs may jointly transmit the paging message of the user equipment. Even though a beam of TRP #1 is blocked, the user equipment may still receive a beam from TRP #2, thereby successfully receiving the paging message.

In an embodiment, the number of the concerned base stations (or TRPs) may be uniformly determined according to any one or more of the following factors: a blocking probability, radio channel quality, and a moving velocity of the user equipment. However, this disclosure is not limited thereto, and other factors may also be taken into account.

In an embodiment, for the base stations (or TRPs) participating in the joint transmission, an indicated beam in the paging set of the user equipment (i.e. selected by the user equipment) is used in transmitting the beam. Hence, information on the beam needs to be interchanged between the base stations (or TRPs).

Hence, via an interface between the base stations (or TRPs), the base stations (or TRPs) may make the paging set and the paging message (optional) of the user equipment shared by all non-serving base stations (or TRPs) participating in the joint transmission.

Alternatively, via an interface (such as an X2 interface) between the base stations (or TRPs), the base stations (or TRPs) may make one or more pieces of the following information shared by all non-serving base stations (or TRPs) participating in the joint transmission: global beam identifiers of the non-serving base stations (or TRPs) in the paging set of the user equipment, internal identities of beams within the base stations (or TRPs), and a paging message.

In an embodiment, the joint transmission of the paging message may be performed in a coherent manner or a non-coherent manner. For example, if information on phases between the base stations (or TRPs) is known, the coherent manner is preferentially used in the joint transmission; otherwise, the non-coherent manner is used in the joint transmission, such as a cyclic delay diversity (CDD). And furthermore, the joint transmission of the paging message may be completely transparent to the user equipment, that is, the user equipment needs only to receive the paging message when the paging occasion arrives; the paging occasion may be determined in the manner described above.

It can be seen from the above embodiments that the paging occasion of the user equipment is determined based on one or more beam identities in the paging set. Hence, when the paging occasion of the user equipment arrives, beams of the base station may be directed to the user equipment, and the paging message may be efficiently and reliably transmitted. And furthermore, the serving base station and the coordination base station jointly transmit the paging message of the user equipment, thereby efficiently resisting blocking by using a beam diversity, and greatly improving an efficiency and reliability of the transmission of the paging message.

### Embodiment 2

These embodiments of this disclosure provide a paging method, applicable to a base station (a serving base station and/or a coordination base station), with contents identical to those in Embodiment 1 being not going to be described herein any further.

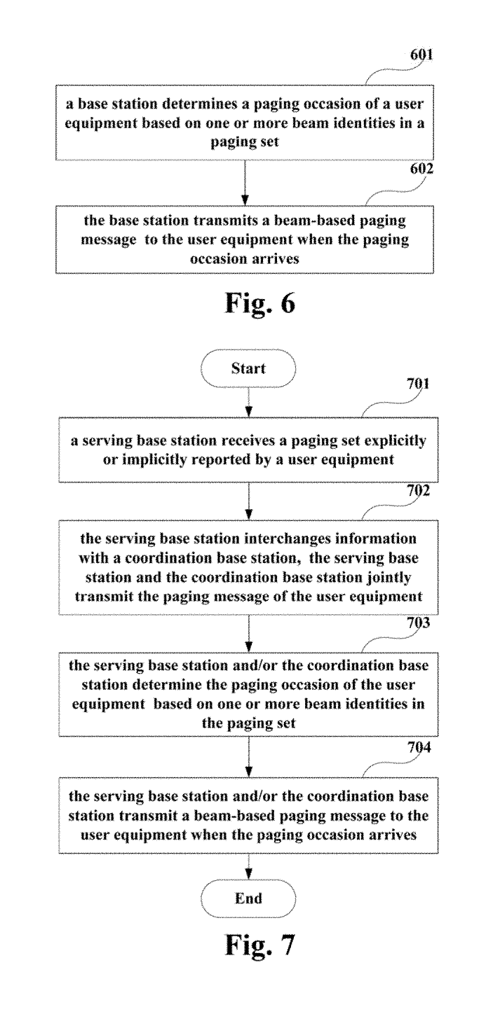

FIG. 6 is a flowchart of the paging method of the embodiment of this disclosure. As shown in FIG. 6, the paging method includes:

Block 601: a base station determines a paging occasion of a user equipment based on one or more beam identities in a paging set; and

Block 602: the base station transmits a beam-based paging message to the user equipment when the paging occasion arrives.

In an embodiment, the paging occasion of the user equipment may also be determined based on one or more beam identities in the paging set and an identity of the user equipment.

In an embodiment, when beam sweeping is at a subframe level, the paging occasion may be expressed as a subframe index in a frame; and when the beam sweeping is at a symbol level, the paging occasion may be expressed as a subframe index in a frame and a symbol index in a subframe, and the beam identity in the paging set may be expressed as a symbol index.

In an embodiment, a manner for determining the paging set by the base station may be as described in Embodiment 1, such as using formula (2) or (3). Furthermore, the base station may adopt a dynamic paging occasion calculation formula as actually demanded, such as switching over between formulae (2) and (3). And the base station may notify the user equipment by using higher layer signaling (such as RRC signaling), and/or physical layer signaling, and/or system information (SI), etc. correspondingly, the user equipment may dynamically switch paging occasion calculation formulae according to corresponding signaling.

In an embodiment, the paging set may be generated by the user equipment based on a received signal strength.

FIG. 7 is another flowchart of the paging method of the embodiment of this disclosure. As shown in FIG. 7, the paging method includes:

Block 701: a serving base station receives a paging set explicitly or implicitly reported by a user equipment.

In an embodiment, the beam identities in the paging set may include: identities of beams transmitted by the serving base station, and/or identities of beams transmitted by other base stations.

As shown in FIG. 7, the paging method may further include:

Block 702: the serving base station interchanges information with a coordination base station; the serving base station and the coordination base station jointly transmit the paging message of the user equipment when the paging occasion of the user equipment arrives.

In an embodiment, the information may include one or more pieces of the following: a user equipment identity of the user equipment, a paging set of the user equipment, a paging message of the user equipment, a beam identity of the serving base station in the paging set of the user equipment, and a beam identity of the coordination base station in the paging set of the user equipment. However, this disclosure is not limited thereto, and other information may also be interchanged.

As shown in FIG. 7, the paging method may further include:

Block 703: the serving base station and/or the coordination base station determines the paging occasion of the user equipment based on one or more beam identities in the paging set; and

Block 704: the serving base station and/or the coordination base station transmit(s) a beam-based paging message to the user equipment when the paging occasion arrives.

In an embodiment, the serving base station and the coordination base station may jointly transmit the paging message of the user equipment.

When information on phases between the serving base station and the coordination base station is known, the serving base station and the coordination base station may jointly transmit the paging message in a coherent manner; or when information on phases between the serving base station and the coordination base station is unknown, the serving base station and the coordination base station may jointly transmit the paging message in a non-coherent manner, such as a cyclic delay diversity.

In an embodiment, the base station may further determine a size of the paging set for the user equipment, and transmit signaling indicating the size of the paging set to the user equipment, so that the user equipment determines the paging set according to the size of the paging set and a result of measurement.

In an embodiment, the paging set may be indicated by the base station for the user equipment, that is, the base station configures the paging set for the user equipment and transmits the paging set to the user equipment, so that the user equipment determines the paging occasion directly according to the paging set.

It can be seen from the above embodiments that the paging occasion of the user equipment is determined based on one or more beam identities in the paging set. Hence, when the paging occasion of the user equipment arrives, beams of the base station may be directed to the user equipment, and the paging message may be efficiently and reliably transmitted. And furthermore, the serving base station and the coordination base station jointly transmit the paging message of the user equipment, thereby efficiently resisting blocking by using a beam diversity, and greatly improving an efficiency and reliability of the transmission of the paging message.

### Embodiment 3

These embodiments of this disclosure provide a paging apparatus, configured in a user equipment. These embodiments correspond to the paging method of Embodiment 1, with contents identical to those in Embodiment 1 being not going to be described herein any further.

FIG. 8 is a schematic diagram of the paging apparatus of the embodiment of this disclosure. As shown in FIG. 8, a paging apparatus 800 includes:

a paging occasion determining unit 801 configured to determine a paging occasion of the user equipment based on one or more beam identities in a paging set; and

a paging message receiving unit 802 configured to receive a beam-based paging message when the paging occasion arrives.

In an embodiment, the paging occasion determining unit 801 may further be configured to determine the paging occasion of the user equipment based on one or more beam identities in the paging set and an identity of the user equipment.

In an embodiment, when beam sweeping is at a subframe level, the paging occasion may be expressed as a subframe index in a frame; and when the beam sweeping is at a symbol level, the paging occasion may be expressed as a subframe index in a frame and a symbol index in a subframe.

In an embodiment, the paging set may be generated by the user equipment based on a received signal strength.

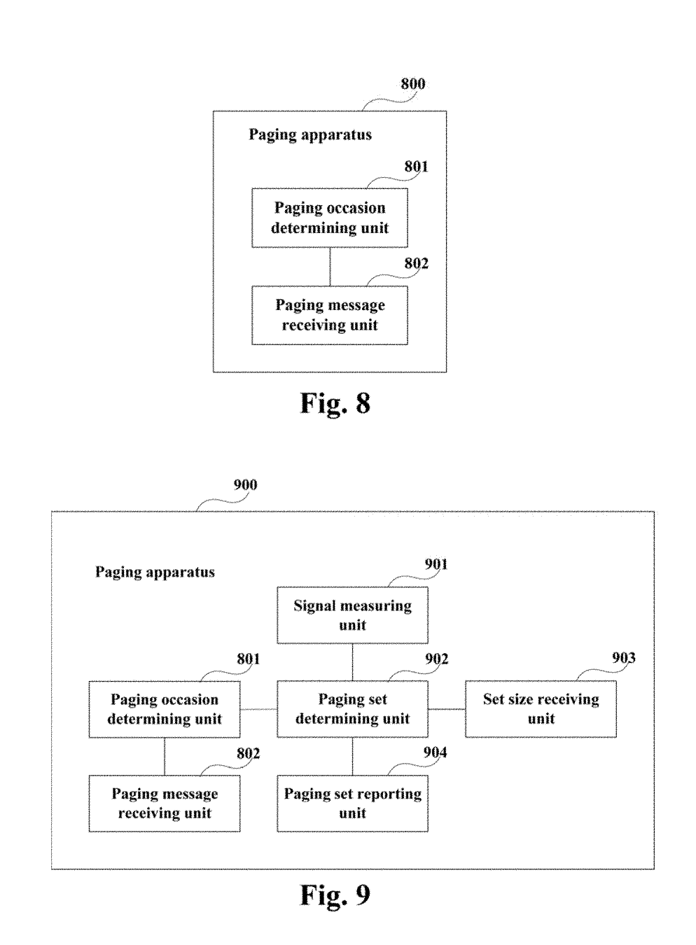

FIG. 9 is another schematic diagram of the paging apparatus of the embodiment of this disclosure. As shown in FIG. 9, a paging apparatus 900 includes a paging occasion determining unit 801 and a paging message receiving unit 802, as described above.

As shown in FIG. 9, the paging apparatus 900 may further include:

a signal measuring unit 901 configured to measure a strength of a beam-based received signal; and

a paging set determining unit 902 configured to determine one or more beam identities in the paging set according to a measurement result.

In an embodiment, the paging set determining unit 902 may be configured to determine beam identities to which a predetermined number of larger measurement values in the result of measurement correspond as the beam identities in the paging set, or determine beam identities to which one or more measurement values in the result of measurement having a difference with a maximum measurement value not exceeding a predetermined threshold correspond as the beam identities in the paging set.

As shown in FIG. 9, the paging apparatus 900 may further include:

a set size receiving unit 903 configured to receive signaling indicating a size of a paging set transmitted by the base station;

and the paging set determining unit 902 may further be configured to determine the one or more beam identities in the paging set according to the size of the paging set and the result of measurement.

As shown in FIG. 9, the paging apparatus 900 may further include:

a paging set reporting unit 904 configured to explicitly or implicitly report the paging set to a serving base station.

In an embodiment, the signal measuring unit 901 may be configured to measure a signal strength of a beam transmitted by the serving base station of the user equipment, and/or may measure signal strengths of beams transmitted by other base stations. And the beam identities in the paging set may include: an identity of the beam transmitted by the serving base station, and/or identities of the beams transmitted by the other base stations.

In an embodiment, the paging message receiving unit 802 may further be configured to receive paging message(s) transmitted by the serving base station and/or the coordination base station when the paging occasion arrives; the serving base station and/or the coordination base station jointly transmit the paging message of the user equipment.

In an embodiment, the paging set may also be indicated by the base station for the user equipment.

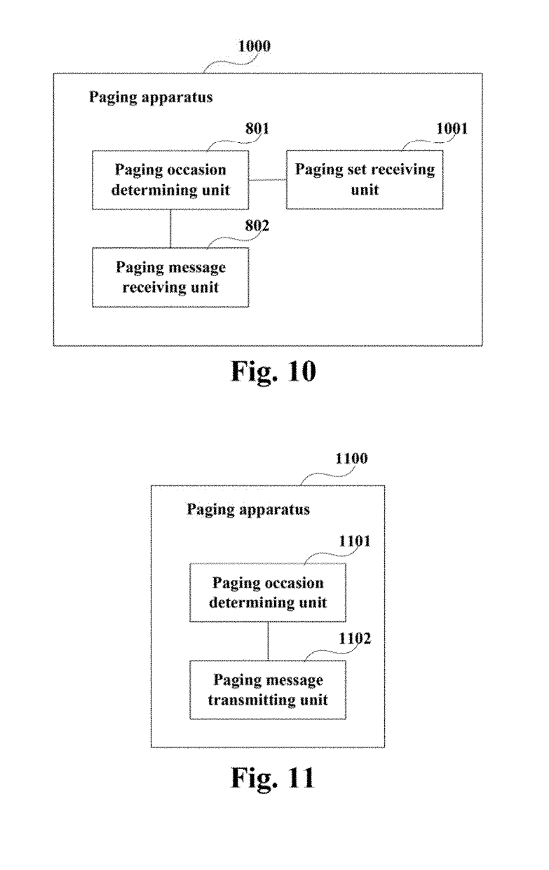

FIG. 10 is a further schematic diagram of the paging apparatus of the embodiment of this disclosure. As shown in FIG. 10, a paging apparatus 1000 includes a paging occasion determining unit 801 and a paging message receiving unit 802, as described above.

As shown in FIG. 10, the paging apparatus 1000 may further include:

a paging set receiving unit 1001 configured to receive a paging set configured for the user equipment and transmitted by the base station.

It can be seen from the above embodiments that the paging occasion of the user equipment is determined based on one or more beam identities in the paging set. Hence, when the paging occasion of the user equipment arrives, beams of the base station may be directed to the user equipment, and the paging message may be efficiently and reliably transmitted. And furthermore, the serving base station and the coordination base station jointly transmit the paging message of the user equipment, thereby efficiently resisting blocking by using a beam diversity, and greatly improving an efficiency and reliability of the transmission of the paging message.

### Embodiment 4

These embodiments of this disclosure provide a paging apparatus, configured in a base station (a serving base station and/or a coordination base station). These embodiments correspond to the paging method of Embodiment 2, with contents identical to those in Embodiment 2 being not going to be described herein any further.

FIG. 11 is a schematic diagram of the paging apparatus of the embodiment of this disclosure. As shown in FIG. 11, a paging apparatus 1100 includes:

a paging occasion determining unit 1101 configured to determine a paging occasion of a user equipment based on one or more beam identities in a paging set; and

a paging message transmitting unit 1102 configured to transmit a beam-based paging message to the user equipment when the paging occasion arrives.

In an embodiment, the paging occasion determining unit 1101 may further be configured to determine the paging occasion of the user equipment based on one or more beam identities in the paging set and an identity of the user equipment.

In an embodiment, when beam sweeping is at a subframe level, the paging occasion may be expressed as a subframe index in a frame; and when the beam sweeping is at a symbol level, the paging occasion may be expressed as a subframe index in a frame and a symbol index in a subframe.

In an embodiment, the paging set may be generated by the user equipment based on a received signal strength.

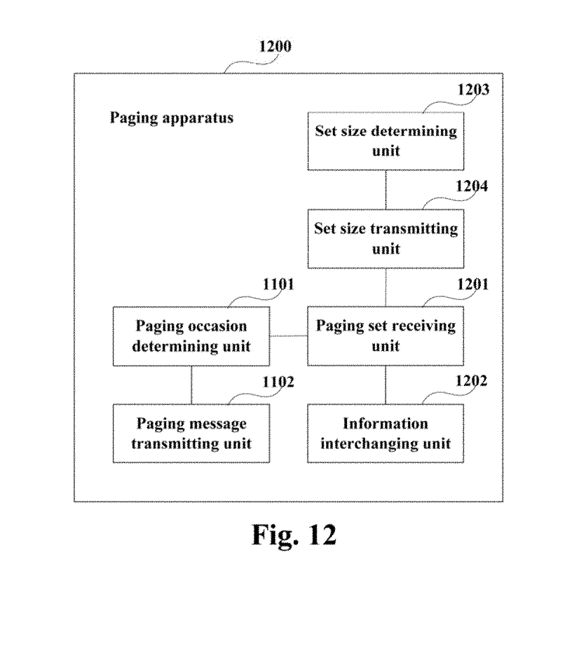

FIG. 12 is another schematic diagram of the paging apparatus of the embodiment of this disclosure. As shown in FIG. 12, a paging apparatus 1200 includes a paging occasion determining unit 1101 and a paging message transmitting unit 1102, as described above.

As shown in FIG. 12, the paging apparatus 1200 may further include:

a paging set receiving unit 1201 configured to receive the paging set explicitly or implicitly reported by the user equipment.

The beam identities in the paging set may include: an identity of the beam transmitted by the serving base station, and/or identities of the beams transmitted by the other base stations.

As shown in FIG. 12, the paging apparatus 1200 may further include:

an information interchanging unit 1202 configured to interchange information with a coordination base station, the base station and the coordination base station jointly transmit the paging message of the user equipment when the paging occasion arrives.

The information includes one or more pieces of the following: a user equipment identity of the user equipment, a paging set of the user equipment, a paging message of the user equipment, a beam identity of a serving base station in the paging set of the user equipment, and a beam identity of the coordination base station in the paging set of the user equipment.

In an embodiment, the paging message transmitting unit 1102 may further be configured to, when information on phases between the serving base station and the coordination base station is known, transmit the paging message jointly with the coordination base station in a coherent manner, or when information on phases between the serving base station and the coordination base station is unknown, transmit the paging message jointly with the coordination base station in a non-coherent manner, such as a cyclic delay diversity.

As shown in FIG. 12, the paging apparatus 1200 may further include:

a set size determining unit 1203 configured to determine a size of a paging set for the user equipment; and

a set size transmitting unit 1204 configured to transmit signaling indicating the size of the paging set to the user equipment.

In an embodiment, the paging set may be indicated by the base station for the user equipment.

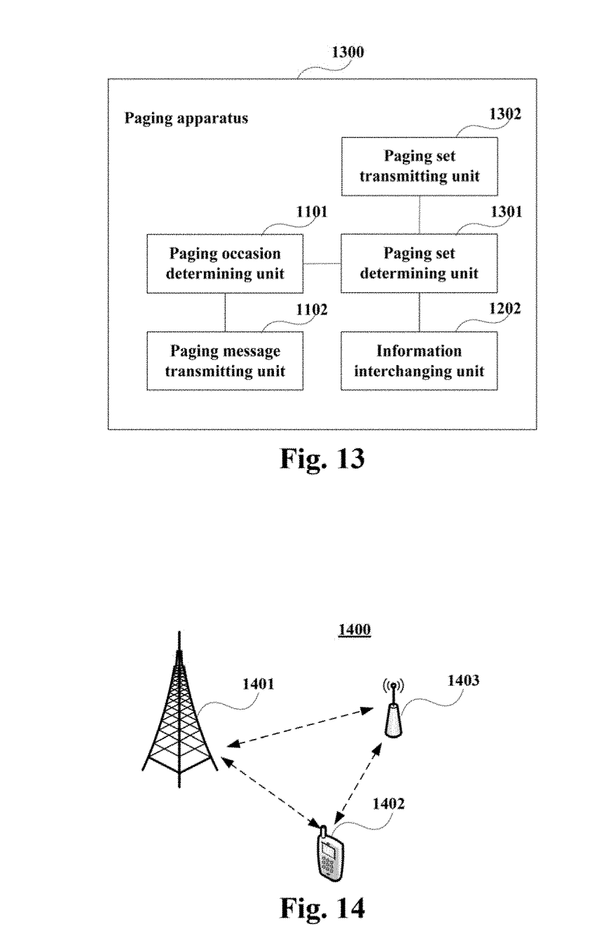

FIG. 13 is a further schematic diagram of the paging apparatus of the embodiment of this disclosure. As shown in FIG. 13, a paging apparatus 1300 includes a paging occasion determining unit 1101, a paging message transmitting unit 1102, and an information interchanging unit 1202, as described above.

As shown in FIG. 13, the paging apparatus 1300 may further include:

a paging set determining unit 1301 configured to configure a paging set for the user equipment; and

a paging set transmitting unit 1302 configured to transmit the paging set to the user equipment.

It can be seen from the above embodiments that the paging occasion of the user equipment is determined based on one or more beam identities in the paging set. Hence, when the paging occasion of the user equipment arrives, beams of the base station may be directed to the user equipment, and the paging message may be efficiently and reliably transmitted. And furthermore, the serving base station and the coordination base station jointly transmit the paging message of the user equipment, thereby efficiently resisting blocking by using a beam diversity, and greatly improving an efficiency and reliability of the transmission of the paging message.

### Embodiment 5

These embodiments of this disclosure further provide a communication system, with contents identical to those in embodiments 1-4 being not going to be described herein any further.

FIG. 14 is a schematic diagram of the communication system of the embodiment of this disclosure. As shown in FIG. 14, the communication system 1400 may include a serving base station 1401 and a user equipment 1402. The user equipment 1402 may be configured with the paging apparatus 800, 900 or 1000 described in Embodiment 3, and the serving base station 1401 may be configured to with the paging apparatus 1100, 1200 or 1300 described in Embodiment 4.

That is, the user equipment 1402 may determine a paging occasion of the user equipment 1402 based on one or more beam identities in a paging set, and receive a beam-based paging message when the paging occasion arrives.

And the serving base station 1401 may determine a paging occasion of the user equipment 1402 based on one or more beam identities in the paging set, and transmit a beam-based paging message to the user equipment 1402 when the paging occasion arrives.

As shown in FIG. 14, the communication system 1400 may further include:

a coordination base station 1403 configured to interchange information with the serving base station 1401, and transmit the paging message of the user equipment 1402 jointly with the serving base station 1401 when the paging occasion arrives.

The embodiment of this disclosure further provides a user equipment.

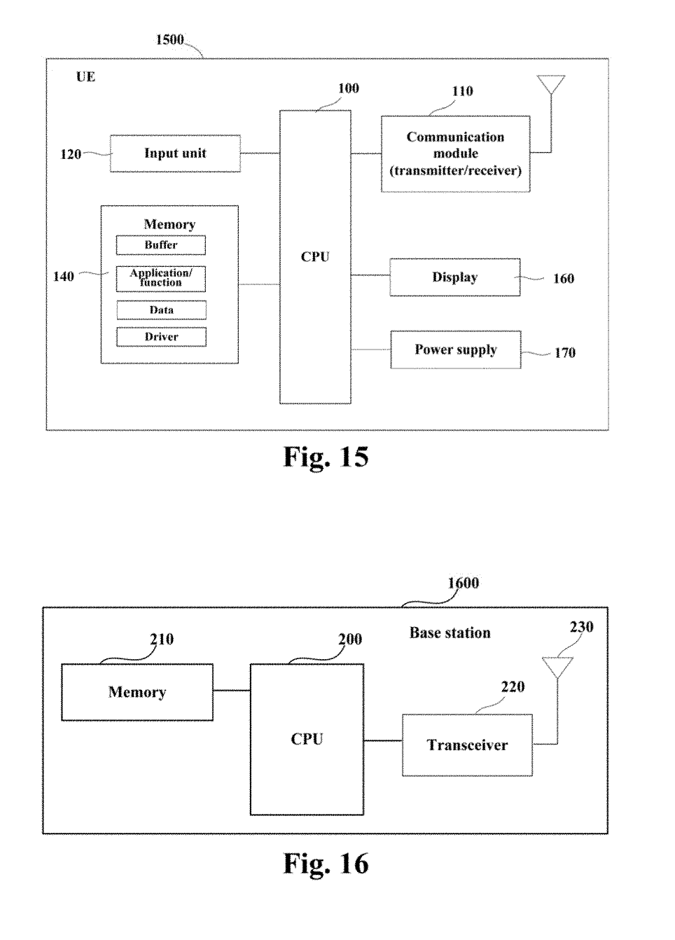

FIG. 15 is a schematic diagram of the user equipment of the embodiment of this disclosure. As shown in FIG. 15, a user equipment 1500 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions. The central processing unit 100 may be configured to carry out the paging method described in Embodiment 1.

For example, the central processing unit 100 may be configured to perform following control: determining a paging occasion of the user equipment 1500 based on one or more beam identities in a paging set; and receiving a beam-based paging message when the paging occasion arrives.

As shown in FIG. 15, the user equipment 1500 may further include a communication module 110, an input unit 120, a display 160 and a power supply 170. Functions of the above components are similar to those in the relevant art, and shall not be described herein any further. It should be noted that the user equipment 1500 does not necessarily include all the parts shown in FIG. 15, and the above components are not necessary; and furthermore, the user equipment 1500 may include parts not shown in FIG. 15, and the relevant art may be referred to.

The embodiment of this disclosure further provides a base station (a serving base station and/or a coordination base station).

FIG. 16 is a schematic diagram of the base station of the embodiment of this disclosure. As shown in FIG. 16, a base station 1600 may include a central processing unit (CPU) 200 and a memory 210, the memory 210 being coupled to the central processing unit 200. The memory 210 may store various data, and furthermore, it may store a program for information processing, and execute the program under control of the central processing unit 200.

For example, the central processing unit 200 may be configured to perform following control: determining a paging occasion of a user equipment based on one or more beam identities in a paging set; and transmitting a beam-based paging message to the user equipment when the paging occasion arrives.

Moreover, the central processing unit 200 may be configured to perform following control: transmitting the paging message of the user equipment jointly with other base station when the paging occasion arrives.

Furthermore, as shown in FIG. 16, the base station 1600 may include a transceiver 220, and an antenna 230, etc. Functions of the above components are similar to those in the relevant art, and shall not be described herein any further. It should be noted that the base station 1600 does not necessarily include all the parts shown in FIG. 16, and furthermore, the base station 1600 may include parts not shown in FIG. 16, and the relevant art may be referred to.

An embodiment of the present disclosure provides a computer readable program code, which, when executed in a paging apparatus or a user equipment, will cause the paging apparatus or the user equipment to carry out the paging method described in Embodiment 1.

An embodiment of the present disclosure provides a storage medium, including a computer readable program code, which will cause a paging apparatus or a user equipment to carry out the paging method described in Embodiment 1.

An embodiment of the present disclosure provides a computer readable program code, which, when executed in a paging apparatus or a base station, will cause the paging apparatus or the base station to carry out the paging method described in Embodiment 2.

An embodiment of the present disclosure provides a storage medium, including a computer readable program code, which will cause a paging apparatus or a base station to carry out the paging method described in Embodiment 2.

The above apparatuses of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory.

The method/apparatus described with reference to the embodiments of this disclosure may be directly embodied as hardware, software modules executed by a processor, or a combination thereof. For example, one or more functional block diagrams and/or one or more combinations of the functional block diagrams shown in FIG. 8 may either correspond to software modules of procedures of a computer program, or correspond to hardware modules. Such software modules may respectively correspond to the steps shown in FIG. 3. And the hardware module, for example, may be carried out by firming the soft modules by using a field programmable gate array (FPGA).

The soft modules may be located in an RAM, a flash memory, an ROM, an EPROM, and an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the figures may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the figures may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A paging apparatus, configured in a base station, the paging apparatus comprising:
a paging occasion determining unit configured to determine a paging occasion of a user equipment (UE) based on one or more beam identities in a paging set; and
a paging message transmitting unit configured to transmit a beam-based paging message to the UE when the paging occasion arrives.

2. The paging apparatus according to claim 1, wherein the paging occasion determining unit is further configured to determine the paging occasion of the UE based on one or more beam identities in the paging set and an identity of the UE.

3. The paging apparatus according to claim 1, wherein the paging apparatus further comprises:
a paging set receiving unit configured to receive the paging set explicitly or implicitly reported by the UE.

4. The paging apparatus according to claim 1, wherein the paging apparatus further comprises:
a set size determining unit configured to determine a size of a paging set for the UE; and
a set size transmitting unit configured to transmit signaling indicating the size of the paging set to the UE.

5. The paging apparatus according to claim 1, wherein the paging apparatus further comprises:
a paging set determining unit configured to configure a paging set for the UE; and
a paging set transmitting unit configured to transmit the paging set to the UE.

6. The paging apparatus according to claim 1, wherein when beam sweeping is at a subframe level, the paging occasion is expressed as a subframe index in a frame; and when the beam sweeping is at a symbol level, the paging occasion is expressed as a subframe index in a frame and a symbol index in a subframe.

7. The paging apparatus according to claim 1, wherein the beam identity/identities in the paging set comprise(s): identity/identities of beam(s) transmitted by a serving base station, and/or identity/identities of beam(s) transmitted by other base station(s).

8. The paging apparatus according to claim 1, wherein the paging apparatus further comprises:
an information interchanging unit configured to interchange information with a coordination base station; wherein the base station and the coordination base station jointly transmit the paging message of the UE when the paging occasion arrives.

9. The paging apparatus according to claim 8, wherein the information comprises one or more pieces of the following: a UE identity of the UE, a paging set of the UE, a paging message of the UE, a beam identity of a serving base station in the paging set of the UE, and a beam identity of the coordination base station in the paging set of the UE.

10. A paging apparatus, configured in a UE, the paging apparatus comprising:
a paging occasion determining unit configured to determine a paging occasion of the UE based on one or more beam identities in a paging set; and
a paging message receiving unit configured to receive a beam-based paging message when the paging occasion arrives.

11. The paging apparatus according to claim 10, wherein the paging occasion determining unit is further configured to determine the paging occasion of the UE based on one or more beam identities in the paging set and an identity of the UE.

12. The paging apparatus according to claim 10, wherein the paging apparatus further comprises:
a signal measuring unit configured to measure a strength of a beam-based received signal; and
a paging set determining unit configured to determine one or more beam identities in the paging set according to a measurement result.

13. The paging apparatus according to claim 12, wherein the paging apparatus further comprises:
a paging set reporting unit configured to explicitly or implicitly report the paging set to a base station.

14. The paging apparatus according to claim 10, wherein the paging apparatus further comprises:
a paging set receiving unit configured to receive a paging set configured for the UE and transmitted by the base station.

15. The paging apparatus according to claim 10, wherein beam identities in the paging set belong to a serving base station of the UE, or belong to the serving base station and other base station(s), or respectively belong to different base stations.

16. The paging apparatus according to claim 10, wherein when beam sweeping is at a subframe level, the paging occasion is expressed as a subframe index in a frame; and when the beam sweeping is at a symbol level, the paging occasion is expressed as a subframe index in a frame and a symbol index in a subframe.

17. The paging apparatus according to claim 12, wherein the signal measuring unit is configured to measure a signal strength of a beam transmitted by the serving base station of the UE, and/or measure a signal strength of a beam transmitted by the other base station;
and the beam identity/identities in the paging set comprise(s): identity/identities of the beam(s) transmitted by the serving base station, and/or identity/identities of the beam(s) transmitted by the other base station(s).

18. The paging apparatus according to claim 10, wherein the paging message receiving unit is further configured to monitor and determine whether there exists a paging message of the UE when the paging occasion arrives, and receive a paging message/paging messages transmitted by the serving base station and/or the coordination base station(s) when there exists a paging message of the UE; and wherein the serving base station and the coordination base station jointly transmit the paging message of the UE.

19. A communication system, comprising:
a serving base station configured to determine a paging occasion of a UE based on one or more beam identities in a paging set, and transmit a beam-based paging message to the UE when the paging occasion arrives; and
a UE configured to determine a paging occasion of the UE based on one or more beam identities in a paging set, and receive a beam-based paging message when the paging occasion arrives.

20. The communication system according to claim 19, wherein the communication system further comprises:
a coordination base station configured to interchange information with the serving base station; wherein the coordination base station and the serving base station jointly transmit the paging message of the UE when the paging occasion arrives.
